(19) United States
(12) Patent Application Publication
(10) Pub. No.: US 2017/0205224 A1
(43) Pub. Date: Jul. 20, 2017

(54) METHOD FOR MANUFACTURING COMPONENT AND MANUFACTURING APPARATUS USING SUCH METHOD, AND VOLUME MEASURING METHOD

(71) Applicant: HITACHI AUTOMOTIVE SYSTEMS, LTD., Ibaraki (JP)

(72) Inventors: Atsushi TANIGUCHI, Tokyo (JP); Kazushi MIYATA, Ibaraki (JP)

(73) Assignee: HITACHI AUTOMOTIVE SYSTEMS, LTD., Ibaraki (JP)

(21) Appl. No.: 15/327,858

(22) PCT Filed: Jun. 22, 2015
(86) PCT No.: PCT/JP2015/067879

§ 371 Date: Jan. 20, 2017

(30) Foreign Application Priority Data
Aug. 29, 2014 (JP) 2014-174756

(51) Int. Cl. G01B 11/00

(52) U.S. Cl. CPC G01B 11/00

(57) ABSTRACT

Conventionally, the volume of a product has been measured by using a method called a light section method only from a single direction. When the inclination of its surface is steep with respect to an incident light ray, the precision is low. The present invention includes a processing step that processes a component, an examination step that measures and calculates the volume of the component discharged from the processing step by using an optical method, an evaluation step that compares the volume value of the component obtained at the examination step with a previously set reference value to determine the quality of the component, a branching step that sorts and branches the component based on the evaluation result of the evaluation step, and a conveyance step that conveys the component branched at the branching step. This provides a method for manufacturing a high-precision component.

### INCORPORATION BY REFERENCE

The present application claims priority from Japanese patent application No. 2014-174756, filed on Aug. 29, 2014, the contents of which are hereby incorporated by reference into this application.

### TECHNICAL FIELD

The present invention relates to a method for manufacturing a component and a manufacturing apparatus using such a method, and a volume measuring method.

### BACKGROUND ART

Patent Literature 1 describes a volume measuring apparatus that emits straight slit light onto an object to be measured, images the light section line of the object to be measured from the position spaced therefrom by a predetermined distance in the direction perpendicular to the longitudinal direction of the slit light to calculate the cross-section area of the object to be measured, relatively moves the slit light in the direction perpendicular to the longitudinal direction thereof, and accumulates the cross-section area obtained from the light section line to measure the volume of the object to be measured, the apparatus having a master clock generator that is supplied with a measurement start signal to generate a master clock, in which based on the master clock, the relative movement of the slit light is carried out, and in which based on the master clock, the light section line for calculating the cross-section area is fetched.

Patent Literature 2 describes a non-contact volume measuring apparatus including a moving table that moves an object to be measured of the measuring apparatus in a predetermined direction by a predetermined distance, a slit light source that emits slit light onto the object to be measured, a camera that photographs slit images when the slit light outputted from the slit light source impinges on the object to be measured, and image processing means that has the function of image-processing three-dimensional data from the slit images obtained from the camera, computing volumes for the respective slit images, and integrating these to calculate a total volume.

### CITATION LIST

### Patent Literature

Patent Literature 1: Japanese Unexamined Patent Application Publication No. Hei7(1995)-208945

Patent Literature 2: Japanese Unexamined Patent Application Publication No. Hei4(1992)-301707

### SUMMARY OF INVENTION

### Technical Problem

In the volume measuring means that applies the shape measurement in Patent Literatures 1 and 2, a method typically called a light section method is used only from a single direction, and when the inclination of the surface is steep with respect to an incident light ray, the precision is lowered so that the desired result cannot be obtained. Consequently, in the manufacturing method that uses such volume measuring means, it has been difficult to manufacture a high-precision product. Accordingly, an object of the present invention is to provide a method for manufacturing a high-precision component.

### Solution to Problem

To solve the above problems, a manufacturing method of the present invention includes a processing step that processes a component, an examination step that measures and calculates the volume of the component discharged from the processing step by using optical means, an evaluation step that compares the volume value of the component obtained at the examination step with a previously set reference value to determine the quality of the component, a branching step that sorts and branches the component based on the evaluation result of the evaluation step, and a conveyance step that conveys the component branched by the branching step.

### Advantageous Effects of Invention

According to the present invention, a high-precision product can be manufactured to improve the product quality control level.

Other objects, features, and advantages of the present invention will be apparent from the description of the following embodiments of the present invention related to the accompanying drawings.

### BRIEF DESCRIPTION OF DRAWINGS

FIG. 1 is a block diagram of a non-contact volume measuring apparatus according to a first embodiment of the present invention.

FIG. 2 is a schematic diagram representing the scanning trajectory of the non-contact volume measuring apparatus according to the first embodiment of the present invention.

FIG. 3 is a flowchart illustrating the measuring procedure of the non-contact volume measuring apparatus according to the first embodiment of the present invention.

FIG. 4 is a schematic diagram representing a measurement surface and the laser incidence direction of a distance sensor according to the first embodiment of the present invention.

FIG. 5 is a schematic diagram illustrating the surface inclination dependence of the measurement error of the distance sensor according to the first embodiment of the present invention.

FIG. 6 is a schematic diagram representing a measureable range when φl=θl=0 according to the first embodiment of the present invention.

FIG. 7 is a schematic diagram representing the optimum value and measureable range of each of three distance sensors according to the first embodiment of the present invention.

FIG. 8 is a schematic diagram representing the integration result of the measurement ranges of the three distance sensors according to the first embodiment of the present invention.

FIG. 9 is a schematic diagram representing the emission position of the three distance sensors according to the first embodiment of the present invention.

FIG. 10 is a flowchart representing the processing procedure of a shape measurement unit according to the first embodiment of the present invention.

FIG. 11 is a data flowchart at the time of calculating shape data according to the first embodiment of the present invention.

FIG. 12 is a schematic diagram of shape data calculation according to the first embodiment of the present invention.

FIG. 13 is a schematic diagram of a calibration reference sample according to the first embodiment of the present invention.

FIG. 14 is a schematic diagram illustrating a volume calculation portion according to the first embodiment of the present invention.

FIG. 15 is a schematic diagram representing height references according to the first embodiment of the present invention.

FIG. 16 is a flowchart representing a good or defective determination procedure by shape comparison according to the first embodiment of the present invention.

FIG. 17 is a diagram illustrating the emission positions of the three distance sensors and the arrangement of polarizing plates according to the first embodiment of the present invention.

FIG. 18 is a block diagram of a non-contact volume measuring apparatus according to a second embodiment of the present invention.

FIG. 19 is a diagram illustrating an apparatus and method for manufacturing a piston according to a third embodiment of the present invention.

FIG. 20 is a flowchart illustrating the apparatus and method for manufacturing the piston according to the third embodiment of the present invention.

### DESCRIPTION OF EMBODIMENTS

### First Embodiment

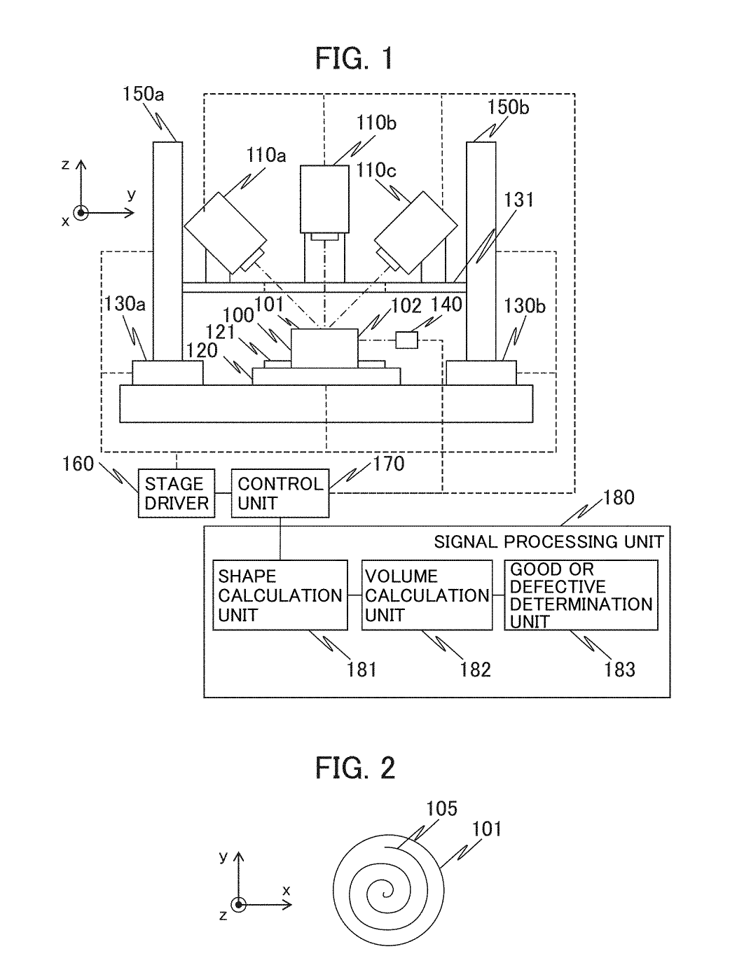

A first embodiment of the present invention will be described with reference to FIGS. 1 to 17.

FIG. 1 illustrates a block diagram of a piston volume examining apparatus of this embodiment. The shape of a measurement surface 101 as the upper surface of a sample 100 is measured by three non-contact type distance sensors 110a to 110c using lasers. While rotating the sample by a rotation stage 120, the distance sensors 110a to 110c helically measure the entire measurement surface 101 by scanning in the x-axis direction with the movement of x-axis stages 130a, 130b. For such distance sensors, considered is the use of various sensors by a light section method based on triangulation, a TOF (Time of Fight) method using optical phase difference, an FMCW (Frequency Modulated Continuous Wave) method, an optical comb method, OCT (Optical Coherence Tomography) using optical interference, and a method applying conoscopic holography. The x-axis stage includes the x-axis stage master shaft 130a, and the x-axis stage slave shaft 130b. These two shafts move at the same time in synchronization with each other, so that a plate 131 on which the distance sensors 110a to 110c are mounted can be stably moved. Here, the distance sensors 110a to 110c are appropriately arranged so as to measure the arbitrary shape of the measurement surface with high precision. The optimization of the arrangement of the sensors will be described later.

FIG. 2 schematically represents a measurement point trajectory 105 when the distance sensors 110a to 110c move on the x-axis for scanning in such a manner that the measurement position thereof is directed from the center of the measurement surface 101 toward the outer periphery thereof. In addition, the piston volume examining apparatus is equipped with a cylinder mechanism 121 that holds and fixes the sample 100 from the outer periphery thereof, a z-axis stage that adjusts the heights of the distance sensors 110a to 110c and the sample 100, and a side surface distance sensor 140 that measures the center position relationship between the sample 100 and the rotation stage 120.

When the sample 100 is approximately cylindrical, the distance between the center of the sample and the center of rotation of the rotation stage 120 is continuously measured by the side surface distance sensor 140 while rotating the rotation stage 120, and the change in distance is then measured. From this, while the rotation stage 120 makes one rotation, the distance changes sinusoidally. The displacement amount between the center of the sample and the center of rotation of the rotation stage 120 can be calculated from the amplitude of the sine wave, and the displacement direction can be calculated from the phase thereof. Thus, the position relationship between the center of the sample and the center of rotation of the rotation stage 120 can be grasped before the measurement.

In addition, when the sample is approximately cylindrical, the center of the sample and the center of rotation are previously matched from the measurement result. Thus, the effect of reducing vibration caused in the entire apparatus by rotation can be obtained. As with the x-axis stage, the z-axis stage includes a z-axis stage master shaft 150a, and a z-axis stage slave shaft 150b, and the two shafts move at the same time in synchronization with each other. Holes are opened in the plate 131 so as to allow lasers from the distance sensors 110a to 110c to reach the measurement surface 101. A stage driver 160 drives the rotation stage 120, the x-axis stages 130a, 130b, and the z-axis stages 150a, 150b. A control unit 170 is used to carry out the synchronous detection of the rotation stage 120, the x-axis stages 130a, 130b, the distance sensors 110a to 110c, and the side surface distance sensor 140. A signal processing unit 180 automatically subject the measurement result to good or defective determination for the sample 100. In addition, the signal processing unit 180 includes a shape calculation unit 181, a volume calculation unit 182, and a good or defective volume determination unit 183.

In this embodiment, the trajectory as illustrated in FIG. 2 is formed by the rotation and movement in the X-axis direction of the stages, but forming the trajectory is not necessarily limited to the movement of the stages. For instance, forming the trajectory is also achieved by rotation and movement in the X-axis direction of the distance sensors. In addition, other than the combination of the rotation and movement in the X-axis direction, it is also possible to adopt movement in the Y-axis direction in place of the rotation, thereby scanning the entire measurement surface by the combination of the movement in the X-axis direction and the movement in the Y-axis direction.

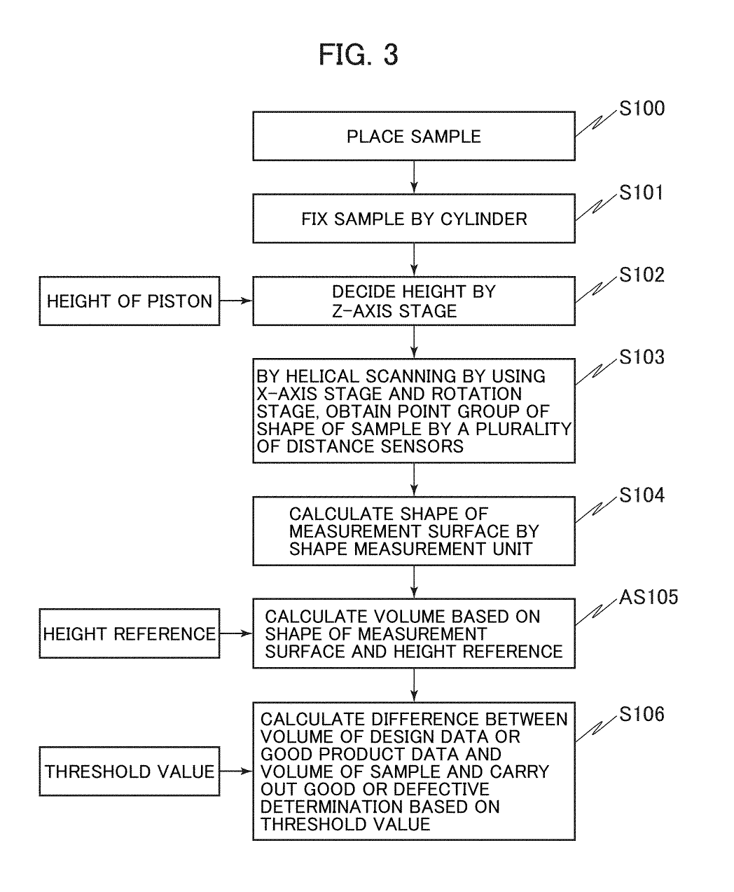

FIG. 3 illustrates an examination flow. The sample is placed on the rotation stage (S100). Then, the sample placed in S100 is held and fixed by the cylinder mechanism 121 (S101). To reduce the distance between the non-contact distance sensors 110a to 110c and the measurement surface to within the working distance of the distance sensors 110a to 110c, the heights thereof are adjusted by the z stages (S102). When the height information of the sample is known, the suitable position of the z-axis stage can be automatically calculated. Then, with scanning by using the rotation stage and the x-axis stage, the measurement surface is measured by the distance sensors, whereby position data is measured from the coordinates of the stages and distance data is measured from the distance sensors (S103). From the position data of the rotation stage, the x-axis stage, and the z-axis stage, and the distance data measured by the distance sensors, which are measured in S103, a measurement point group distributed in the three-dimensional coordinate system is calculated to calculate the shape of the measurement surface from the measurement point group of the three distance sensors (S104). From the shape calculated in S104, an additionally given height reference value is used to calculate the volume of the measurement surface (S105). The calculated volume is compared with the volume calculated from design data or the volume of a Good sample calculated in the same manner by the procedure in S100 to S105, thereby carrying out the good or defective determination that determines that the sample below a previously set threshold value is a good product, and the sample above the threshold value is a defective product (S106).

### (Optimization of the Arrangement of the Distance Sensors)

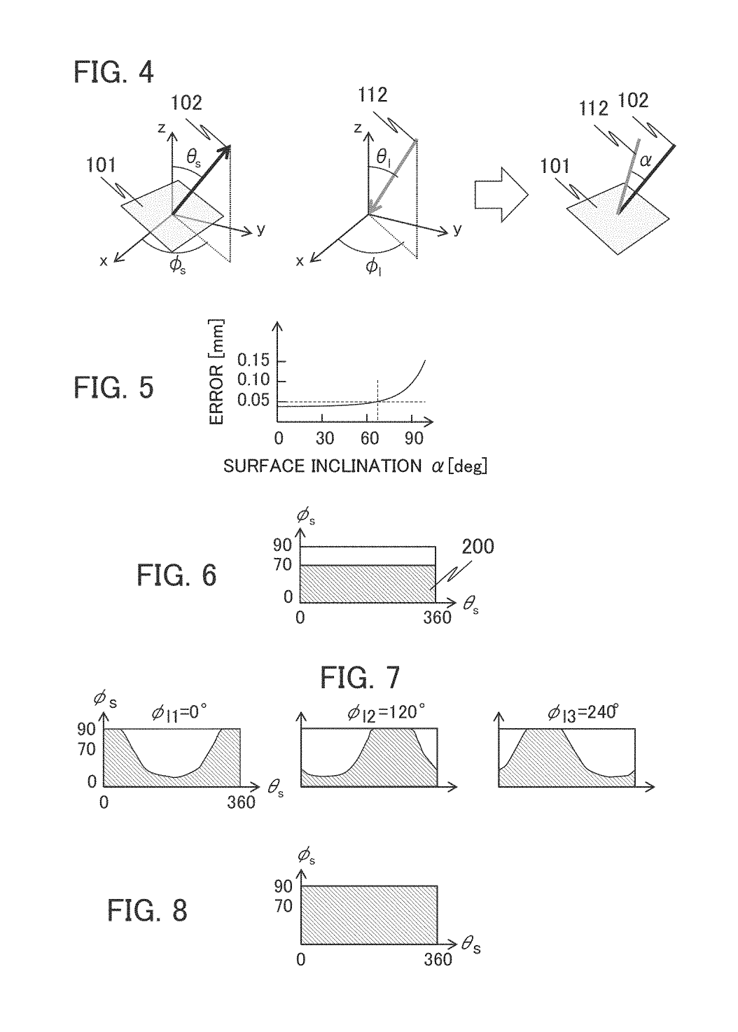

FIG. 4 illustrates a schematic diagram representing the measurement surface and the laser incidence direction of the distance sensor. The distance sensors 110a to 110c illustrated in FIG. 1 are required to be appropriately arranged so as to measure the arbitrary shape of the measurement surface 101. Here, the measurement precision of the non-contact distance sensor using laser greatly depends on the inclination of the measurement surface. As illustrated in FIG. 4, θs, φs represent the direction of a normal vector 102 of the measurement surface, and θl, φl represent the direction of an incident laser direction vector 112 of the distance sensor. In addition, l represents a distance to be measured. α represents the absolute value of the angle formed between the normal vector 102 of the measurement surface 101 and the incident laser direction vector 112 of the distance sensor. FIG. 5 illustrates an example of the α dependence of the measurement error of the distance sensor. Typically, the measurement error tends to be larger as α increases. Thus, the α dependence of the error illustrated in FIG. 5 is previously obtained as basic data to set the maximum value of the error necessary for measurement, so that the maximum value of α that is a criterion for deciding the apparatus configuration can be decided.

Here, the optimization of the setting condition of the distance sensor will be considered. It is assumed that θs, φs that represent the direction of the measurement surface include all surface directions in which 0<θs<90, 0<φs<360. α<αth is a measurable range. FIG. 6 illustrates whether measurement with respect to the direction of the measurement surface is enabled when the incidence direction of the distance sensor is θl=0, φl=0. The diagonally shaded portion is a measureable region 200. When the area of the measureable region with respect to the area of the entire region in which 0<θs<90, 0<φs<360 is coverage ratio γ, γ=αth/90. The setting positions of a plurality of distance sensors are combined to search for the condition in which γ=1. The setting positions of the distance sensors are optimization conditions. When the measurable region when θl=θli, φl=φl=φli is Ai, coverage ratio γ can be expressed by

$$γ = \frac{{{⋃}_{l}}^{N} Ai ( {θ}_{li} , {φ}_{li} )}{90 \times 360} \qquad ( Equation 1 )$$

Here, N represents the number of combinations. The condition in which γ=1 is achieved at the smallest N is searched for. For instance, αth=70° is assumed to determine the optimum conditions, θl1=θl2=θl3=45°, |φl1−φl2|=|φl2−φl3|=|φl3−φl1|=120 or 240° are calculated.

FIG. 7 represents each condition when φl1=0. FIG. 8 represents a region in which three conditions are combined. By carrying out such optimization, the configuration of the measuring apparatus corresponding to all shapes by a smallest number of times of measurement can be derived. To improve the throughput, the apparatus configuration in FIG. 1 is equipped with three sensors for measuring the three detection conditions at the same time. By carrying out the measurement three times with one distance sensor, γ=1 can also be achieved.

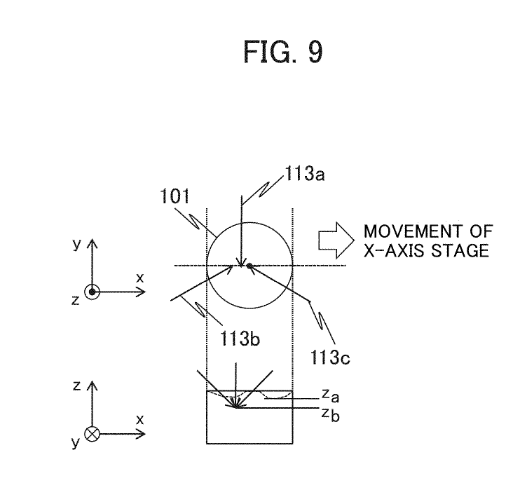

Here, the apparatus configuration when the three distance sensors are handled at the same time will be described. In the distance sensors using lasers, lasers generated from the distance sensors are emitted onto the sample to be measured, reflection and scattering light from the measurement surface is received, and the distance is measured from the phase and intensity information thereof. When plural distance sensors are used and the reflection and scattering light from the measurement surface generated from the incident lasers 113a to 113c from one of the distance sensors is received, the distance measurement precision can be lowered. This lowered measurement precision can be solved by devising the apparatus configuration so as to prevent a laser beam of another distance sensor from being incident on the light receiving surfaces of the other distance sensors. FIG. 9 illustrates its example. The apparatus configuration including the three distance sensors is assumed, in which the lasers from the distance sensors are emitted onto the sample. Here, the light receiving surfaces of the distance sensors are coaxial with the incident lasers. Za is the lowest point of the z-axis at the measurement position of the measurement surface. In addition, Zb is the z-axis coordinate at the intersection of the lasers from the three distance sensors. To space the spots of the distance sensors on the surface of the sample from each other by d,

d=(Zₐ−Z_{b})tan⁻¹ (Equation 2)

is set.

Here, θ represents the inclination of the distance sensors from the z-axis. In this example, the three distance sensors are inclined at 45°. This time, it is considered that the lasers intersect at the position where z is smaller than the measurement surface, and when z is larger than the measurement surface, consideration is given in the same manner, so that the laser spots on the measurement surface can be spaced from each other. As described above, by spacing the laser spot positions of the distance sensors from each other above a fixed distance so that they are not overlapped with each other, it is possible to use the plurality of distance sensors at the same time without lowering the shape measurement precision. The distance d between the spots is appropriately decided in consideration of the distance sensors used and the state of the surface to be measured. For instance, when more scattering light is generated, d is required to be slightly larger.

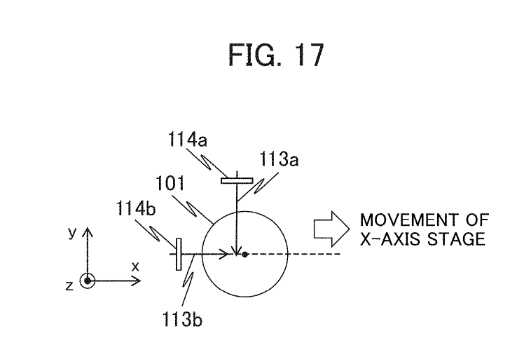

In addition, FIG. 17 illustrates the apparatus configuration in which polarizing plates 114a, 114b are arranged before the distance sensors to further reduce the influence of noise from a different laser. The polarizing plate 114a is set in the direction transmitting the incident laser 113a of the distance sensor. To hold the similar polarization state, the reflection and scattering light from the sample transmits through the polarizing plate 114a, and is then detected for distance measurement. Likewise, the direction of the polarizing plate 114b is set according to the incident laser 113b. Here, since the incident lasers 113a and 113b have different incidence directions, the reflection and scattering light by the incident laser 113a is reduced by the polarizing plate 114b, and likewise, the reflection and scattering light by the incident laser 113b is reduced by the polarizing plate 114a. In this way, the laser beam by the different distance sensor is reduced by the polarizing plate, so that the lowering of the precision can be prevented.

### (Signal Processing Unit)

The signal processing unit automatically subjects the distance measurement result by the distance sensors to various processes to the final good or detective determination for the sample. Here, the signal processing unit includes the shape calculation unit that calculates the shape from stage position information and distance information between the material and the distance sensors measured by the distance sensors, the volume calculation unit that calculates the volume over the crown surface of the piston by using the shape calculated by the shape calculation unit and an arbitrarily set height reference, and the good or defective determination unit that carries out the good or defective determination for the volume calculated by the volume calculation unit. The respective units will be described below in detail.

### (Shape Calculation Unit)

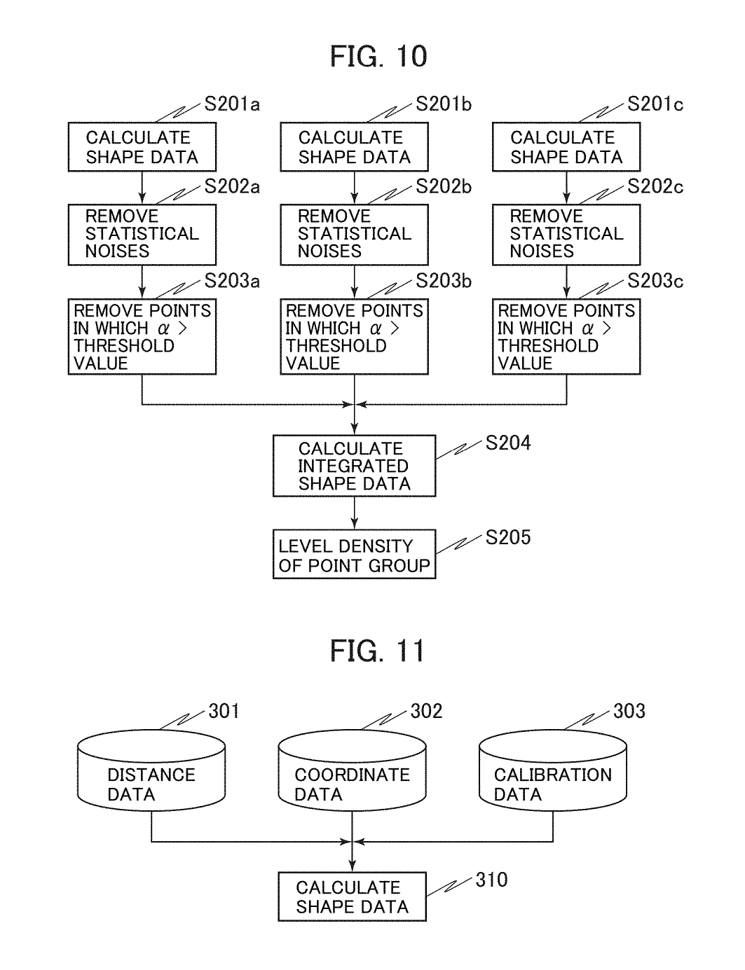

FIG. 10 illustrates the flow of the shape calculation unit. FIG. 11 illustrates a flowchart of data at the time of calculating shape data. As illustrated in FIG. 11, from distance data 301 from each distance sensor, coordinate data 302 of the x-axis stage and the θ stage, and calibration data 303 that represents the position relationship between the distance sensor and the stages, measurement points are converted to an xyz coordinate system to calculate shape data (point group) 310 (S201a to S201c). Any noise components, such as any outliers, are removed from the shape data calculated in S201a to S201c by a statistical process (S202a to S202c). Any points in which angle α formed between the laser incidence direction of the distance sensor and the direction of the measurement surface is above a threshold value and the precision is assumed to be low are removed from the shape data from which any noises are removed in S202a to S202c (S203a to S203c).

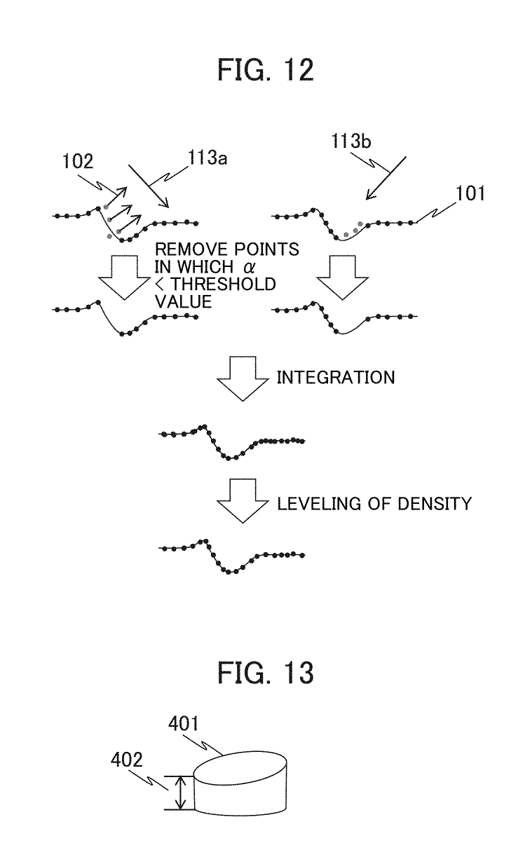

FIG. 12 is a concept view of the process of the shape calculation unit. Here, for simplification, the point group is represented in two dimensions. The measurement points are represented as points with respect to the measurement surface 101 indicated by a solid line. First, the normal direction of each measurement point is estimated. By focusing on the measurement point noted, a region is set in a three-dimensional space, and the normal line is then estimated from the statistical distribution of the points included in the region. To estimate the normal line, principal component analysis (PCA) is used. First, the center of gravity of the measurement point group in the set region is calculated, and a variance-covariance matrix is then generated from the difference between the center of gravity and the points. This variance-covariance matrix is a 3×3 matrix, and has three eigenvalues. In the case of the crown surface measurement, the measurement points form a plane so that one of the three eigenvalues takes a small value with respect to the other two eigenvalues. Here, the direction of the small eigenvalue represents the normal direction of the measurement point group in the region. This normal direction is the normal vector 102 of the measurement point noted. At this time, the region may be set so that the number of points is fixed, or may have a predetermined shape and volume. When the incident laser direction of the distance sensor is known, the surface direction of each point calculated from the above principal component analysis is used to obtain shape data in which any unsuitable points are removed. The point groups representing the shape data calculated in S203a to S203c are aligned and integrated by using ICP, thereby obtaining integrated shape data (S204). The density of the integrated shape data calculated in S204 can be greatly different according to place. In particular, the flat portion has the measurement values by any distance sensor, and tends to have a density higher than the inclined portion. At the location where the density of the point group is high more than necessary, it takes a long time for later processes. Thus, the location is subjected to a process for lowering the density to level the density of the point group for each place (S205), thereby obtaining final high-precision shape data.

Here, a method for obtaining the calibration data 303 representing the position relationship between the distance sensor and the stages will be described. As illustrated in FIG. 13, a reference sample includes a reference plane (a plane with fixed inclination) 401, and a known reference height 402. Such a reference sample is used to carry out the measurement, thereby correcting the position relationship between the distance sensor and the stages. Specifically, calibration data θl, φl, and l of each distance sensor so that the measurement value becomes the design value of the reference sample are calculated for each distance sensor.

### (Volume Calculation Unit)

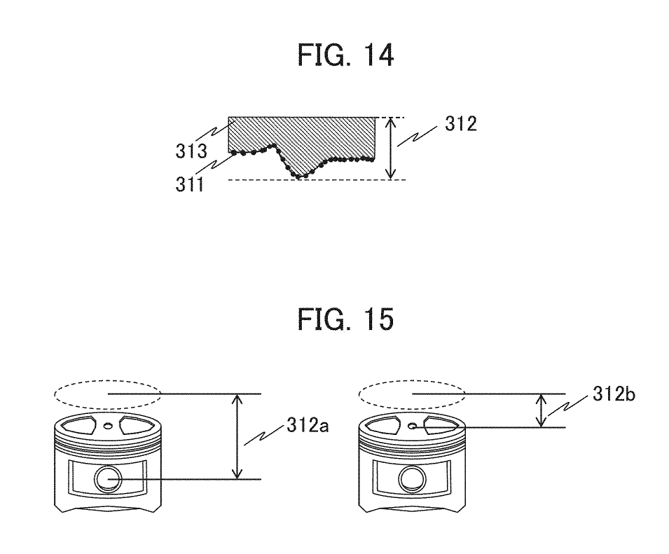

The volume calculation unit will be described with reference to FIG. 14. A volume 313 of the region including high-precision shape data obtained by the shape calculation unit and an arbitrary height reference 312 is calculated to be the volume of the upper surface of the sample. At this time, when the sample 100 is the piston illustrated in FIG. 15, the height reference 312 includes a height reference 312a from the center position of the pin hole of the piston to a fixed height, or a height reference 312b from a portion of the top of the crown surface to a fixed height. When the height reference 312b is used over the crown surface, the height reference 312b is previously created at the time of manufacture so that higher-precision volume examination is enabled.

### (Good or Defective Determination Unit)

The good or defective determination unit determines the volume calculated by the volume calculation unit is good or defective. For instance, a threshold value is set to a design value or a volume determined by a good product, whereby the sample above the threshold value is a defective product, and the sample below the threshold value is a good product. In addition, when any defective value continues from the tendency of the good or defective determination, feedback to the manufacturing process can be carried out. The sample that is a cast product leads to early finding of the wear of the die and chipping. Further, the high-precision shape data calculated by the shape calculation unit is compared with the design shape or the good product shape, so that it is possible to precisely specify the wear of the die and the amount and portion of chipping with higher precision.

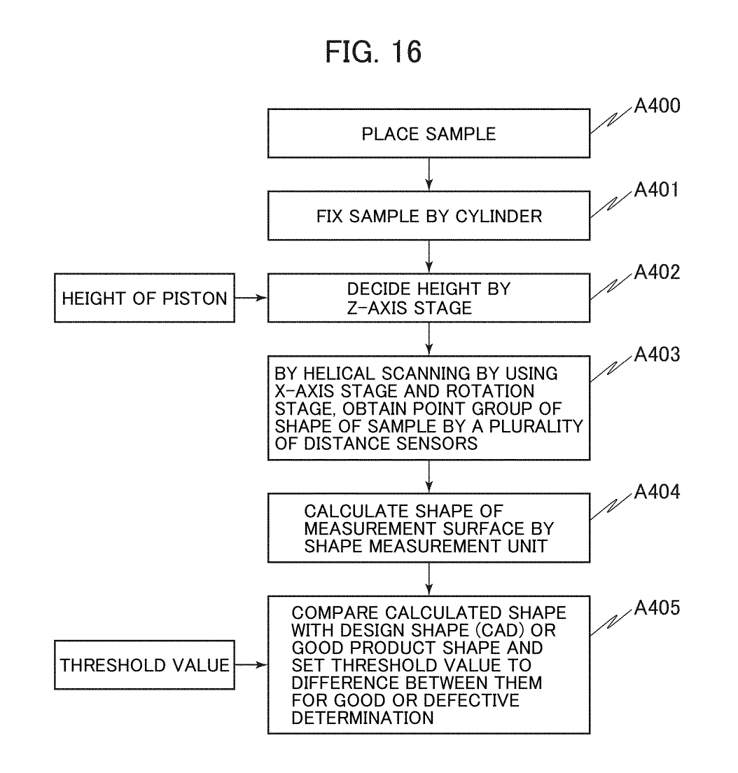

FIG. 16 illustrates the processing flow of the good or defective determination unit. S401 to S404 are the same process as S101 to S104 illustrated in FIG. 3. Shape data calculated in S404 is compared with the design shape (CAD: Computer Aided Design) or the good product shape, and a threshold value is then set to the difference between them to carry out the good or defective determination. For instance, there are indexes, such as the standard deviation of the displacement amount of each point, a maximum displacement amount, an average displacement amount, and a displacement amount obtained by weighting and calculating an important location.

### Second Embodiment

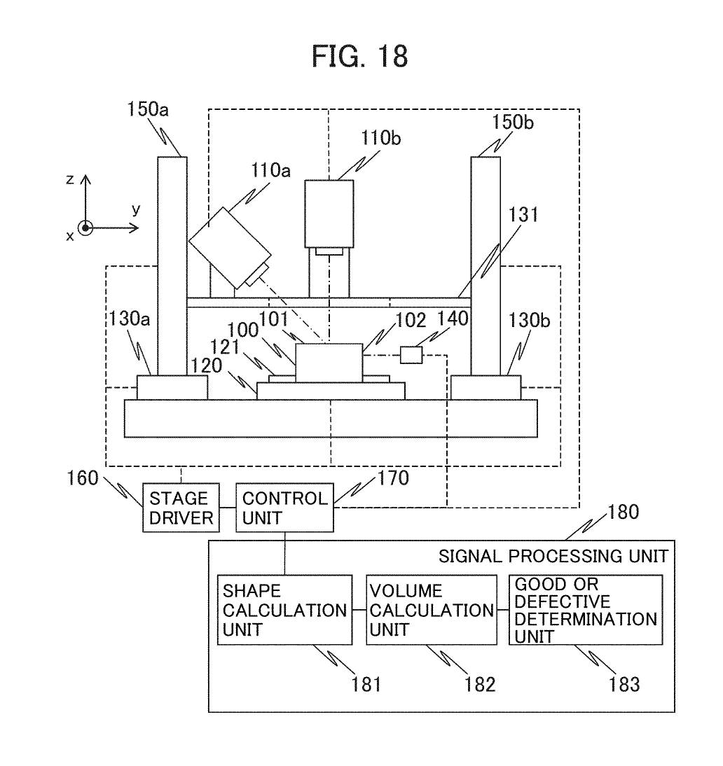

A second embodiment of the present invention will be described with reference to FIG. 18. In FIG. 1 illustrating the first embodiment, the piston volume examining apparatus is equipped with three distance sensors, but in FIG. 18 illustrating this embodiment, it is equipped with two distance sensors. In the first embodiment, the scan distance by the x-axis stage 130 is from the center of the sample to the outer periphery thereof. In this case, the three distance sensors are required to be combined for measuring the arbitrary shape of the measurement surface 101 with high precision. In the second embodiment, by scanning at the scan distance by the X-axis stage 130 that is the diameter of the sample from the outer periphery thereof to the outer periphery thereof passing through the center of the sample, whereby the two distance sensors can measure the arbitrary shape of the measurement surface 101.

In this case, when the optimization of the arrangement of the sensors is carried out like the first embodiment, θl1=θl2=45°, |φl1−φl2|=90° are derived.

In the second embodiment, since the number of sensors is two, the apparatus configuration is simpler than the first embodiment to reduce the cost. On the other hand, since the measuring time is doubled, it is desirable to use the configuration of the first embodiment for carrying out high-speed examination. The processing sensors that are the two distance sensors are not limited to the arrangement in FIG. 18, and can be arranged at arbitrary positions.

### Third Embodiment

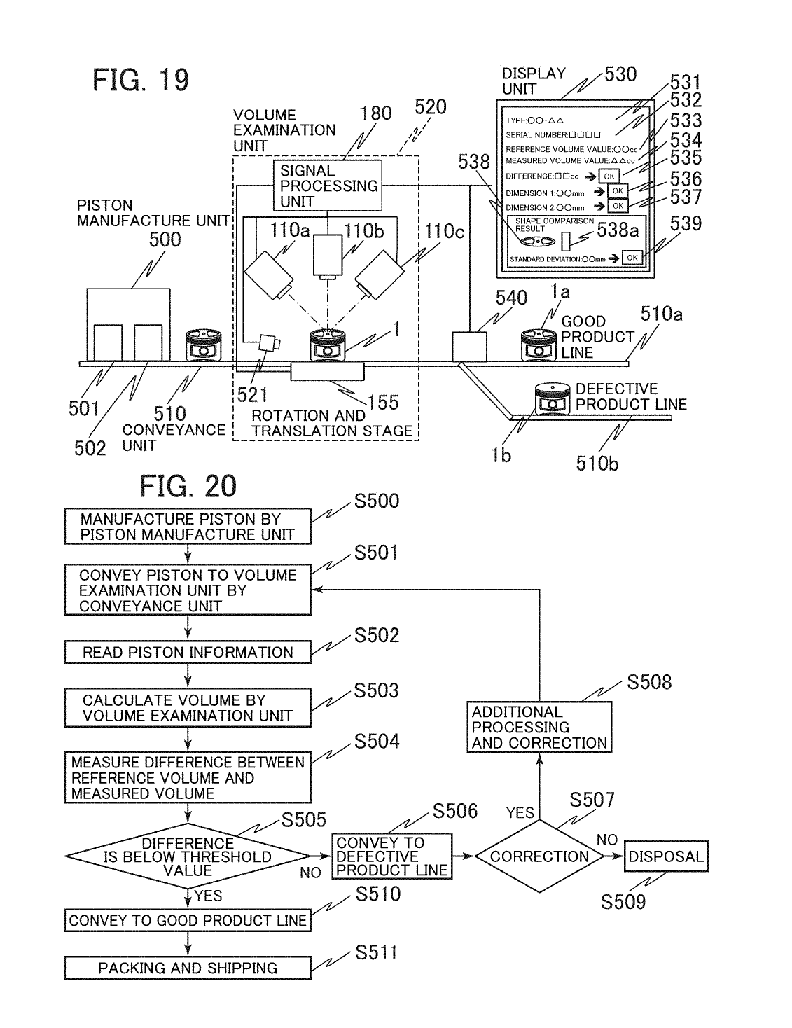

A third embodiment of the present invention will be described with reference to FIGS. 19 and 20. FIG. 19 illustrates a process for examining the processed piston by the volume examination unit arranged in the piston manufacturing line. The piston volume examining apparatus includes a piston processing unit 500 that processes a piston 1, a conveyance unit 510 that conveys the processed piston 1, a volume examination unit 520 that examines the volume of the piston, a display unit 530 that displays the good or defective determination result from the volume examination unit, a branching unit 540 that branches the conveying paths for a good piston 1a and a defective piston 1b according to the good or defective determination result, a good product line 510a that conveys the good piston 1a that has passed the examination, and a defective product line 510b that conveys the defective piston 1b that has failed the examination.

The detail of the respective portions will be described with reference to an examination flowchart in FIG. 20. The piston 1 is processed by the piston processing unit 500 including a casting step 501 and a machining step 502, and the type and identifiable number, such as a serial number, of the piston are given, whereby the information is marked onto the piston 1 by stamping (S500). The piston 1 processed in S500 is conveyed to the volume examination unit 520 by the conveyance unit 510 (S501). The type and serial number of the piston 1 conveyed in S501 are read by an information reading unit 521 (S502). Subsequently, distance measurement is carried out by the three distance sensors 110a, 110b, and 110c and a rotation and translation stage 155, and the volume is then calculated by the signal processing unit 180 based on the measurement data (S503). In addition, the signal processing unit 180 measures the difference between the calculated measured volume and the reference volume (S504), carries out the good or defective determination by the threshold value determination (S504), and displays the result on the display unit 530 together with the information read by the information reading unit 521. Since the apparatus configuration, the volume calculation method, and the good or defective determination method of the volume examination unit 520 are the same as the first embodiment, the detail is omitted. The display unit 530 displays a type 531 of the piston 1, a serial number 532, a reference volume value 533, a measured volume value 534, the difference between the reference volume value and the measured volume value, and a good or defective determination result 535. The piston 1 determined to be good or defective by the signal processing unit 180 is conveyed by being branched as the good piston 1a or the defective piston 1b by the branching unit 540. The defective piston 1b is conveyed to the defective product line 510b (S506). It is determined whether the defective portion is additionally processed and corrected (S507). When the defective portion is additionally processed and corrected, it is conveyed to the volume examination unit again (S508). When the defective portion is not additionally processed and corrected, it is disposed of as-is (S509). The determination whether the defective portion is additionally processed and corrected or is disposed of as-is is decided from the result of the volume examination. For instance, when the volume is small, the processing is considered to be insufficient, whereby the location at which the processing is insufficient is additionally processed. In addition, it is possible to estimate the malfunction of the processing apparatus from defective product frequency and tendency. On the contrary, the piston 1 determined to be a good product is conveyed as the good piston 1a to the good product line 510a (S510), and is then packed and shipped (S511).

In addition, the history of the number and types of defective products are stored, and when a specific number of defective products exceeds a fixed rate, the processing conditions of the casting step 501 and the machining step 502 of the processing unit 500 are changed, or the processing is stopped, so that the quality of the piston processed can be ensured.

Since the volume examination unit 520 calculates the volume of the piston from its shape, the good or defective determination can also be carried out by comparing the measured piston shape with the reference piston shape based on the design information and the result obtained by measuring the piston found to be a good product. When the good or defective determination is carried out according to shape, a threshold value is provided to the dimension to be managed or the magnitude of the deviation between the different locations obtained by comparing the measured shape and the reference shape. When there are a plurality of indexes, an integration index obtained by weighting and summing them may be set to carry out the threshold value processing with respect to the integration index. In this case, the display unit 530 displays dimensions 536, 537, a shape comparison result 538, a color bar 538a that represents the magnitude of a deviation, and a standard deviation 539 of the comparison result.

In addition, the type of a defect is identified and classified from a defective shape, whereby the problem step can be specified to automatically change the condition of the processing step, or to stop the manufacturing line. The measured defect is classified according to dimension, aspect ratio, depth, the volume of the defective portion, and caused location. According to the classification result of the defect, the location in the processing step where the problem occurs is estimated from the past processing data or the feature of the physical process, thereby giving an improvement or stop command according thereto. In the case of using the past processing data, the past data is analyzed, and the type of the caused defect and the step that actually becomes the problem are then stored in a table, thereby specifying the problem step according to the caused defect. In the case of using the feature of the physical process, a recessed defect is determined to be a blow hole to estimate that the casting step is the cause, and a defect having a high aspect ratio is determined to be a flaw to estimate that it is caused in the processing step. In this way, the use of the crown surface shape for the examination in the piston manufacture can specify and improve the problem step more closely than the use of only the volume over the crown surface.

All the embodiments described above are illustrative only for embodying the present invention, and do not limitatively interpret the technical range of the present invention. That is, the present invention can be embodied in various forms without departing from its technical idea or its main features.

The above description has been made for the embodiments, but the present invention is not limited thereto, and it apparent to those skilled in the art that various changes and modifications can be made by the spirit of the present invention and within the scope of the attached claims.

### LIST OF REFERENCE SIGNS

1 Piston
1a Good piston
1b Defective piston
100 Sample
101 Measurement surface
102 Normal vector
105 Trajectory
110a to 110c Distance sensor
112 Incident laser direction vector
113a to 113c Incident laser
114a, 114b Polarizing plate
120 Rotation stage
121 Cylinder mechanism
130a x-axis stage master shaft
130b x-axis stage slave shaft
131 Plate
140 Side surface distance sensor
150a z-axis stage master shaft
150b z-axis stage slave shaft
160 Stage driver
170 Control unit
180 Signal processing unit
181 Shape calculation unit
182 Volume calculation unit
183 Good or defective determination unit
200 Measurable region
301 Distance data
302 Coordinate data
303 Calibration data
310 Shape data
311 High-precision shape data
312, 312a, 312b Height reference
313 Volume
401 Reference plane
402 Reference height
500 Piston processing unit
501 Casting step
502 Machining step
510 Conveyance unit
510a Good product line
510b Defective product line
520 Volume examination unit
521 information reading unit
530 Display unit
531 Type
532 Serial number
533 Reference volume value
534 Measured volume value
535 The difference between the reference volume value and the measured volume value
536, 537 Dimension
538 Shape comparison result
538a Color bar that represents the magnitude of a deviation
539 The standard deviation of the comparison result
540 Branching unit

1. A method for manufacturing a component having a predetermined spatial volume, comprising:
a processing step that processes the component;
an examination step that measures and calculates the volume of the component discharged from the processing step by using optical means;
an evaluation step that compares the volume value of the component obtained at the examination step with a previously set reference value to determine the quality of the component;
a branching step that sorts and branches the component based on the evaluation result of the evaluation step; and
a conveyance step that conveys the component branched by the branching step.

2. The method according to claim 1,
wherein the examination step includes:
a step of measuring the distance between a plurality of distance sensors and the component by the distance sensors by using the optical means;
a step of calculating the three-dimensional distribution of the shape of the component from a data group including at least the measured distance data, the position information of the scanning unit, and the relative position data of the distance sensor and the scanning unit; and
a step of calculating the shape of the component from a measurement point group in which any measurement points in which the angle formed between the direction of the distance sensor and the direction of a measurement surface calculated from the data group is above a predetermined value are removed.

3. The method according to claim 2,
wherein the shape is calculated by removing, among the calculated shape data, the shape data including measurement points in which the difference between the shape data and the different shape data including measurement points is above a predetermined value, from basic data for shape calculation.

4. The method according to claim 2,
wherein the shape data obtained from the distance sensors is integrated to level the density of the measurement point group of the integrated shape data.

5. An apparatus for manufacturing a component having a predetermined spatial volume, comprising:
a processing unit that processes the component;
an examination unit that measures and calculates the volume of the component discharged from the processing unit by using optical means;
an evaluation unit that compares the volume value of the component obtained by the examination unit with a previously set reference value to determine the quality of the component;
a branching unit that sorts and branches the component based on the evaluation result of the evaluation unit; and
a conveyance unit that conveys the component branched by the branching unit.

6. The apparatus according to claim 5,
wherein the examination unit includes:
a distance measurement unit that includes a plurality of distance sensors using the optical means;
a scanning unit that scans at least one of the component and the distance measurement unit; and
a shape calculation unit that calculates the three-dimensional distribution of the shape of the component from a data group including at least distance data obtained by the distance measurement unit, position information data of the scanning unit, and the relative position data of the distance sensor and the scanning unit, and calculates the shape of the component from a measurement point group in which any measurement points in which the angle formed between the direction of the distance sensor and the direction of a measurement surface calculated from the data group is above a predetermined value are removed.

7. The apparatus according to claim 6,
wherein the shape calculation unit further calculates the shape by removing, among the calculated shape data, the shape data including measurement points in which the difference between the shape data and the different shape data including measurement points is above a predetermined value, from basic data for shape calculation.

8. The apparatus according to claim 6, further comprising a distance measurement sensor for calculating the center of the component and the center of rotation.

9. The apparatus according to claim 6,
wherein the shape calculation unit further integrates the shape data obtained from the distance sensors to level the density of the measurement point group of the integrated shape data.

10. The apparatus according to claim 6,
wherein the evaluation unit calculates the volume of a region surrounded by the shape calculated by the shape calculation unit and a predetermined reference height, and determines that the component is a defective product when the difference between the calculated volume and a design value is above a predetermine value.

11. The apparatus according to claim 10,
wherein when the rate of defective products is above a fixed value based on the determination result from the determination unit, the condition of a manufacture step is automatically changed or a manufacturing line is stopped.

12. The apparatus according to claim 5,
wherein the component is a piston.

13. The apparatus according to claim 5,
wherein the processing unit carries out casting or machining.

14. A volume measuring method comprising:
a step of measuring the distance between a plurality of distance sensors and the sample by the distance sensors by using optical means;
a step of calculating the three-dimensional distribution of the shape of the sample from a data group including at least the measured distance data, the position information of the scanning unit, and the relative position data of the distance sensor and the scanning unit; and
a step of calculating the shape of the sample from a measurement point group in which any measurement points in which the angle formed between the direction of the distance sensor and the direction of a measurement surface calculated from the data group is above a predetermined value are removed.
